(19) United States
(12) Patent Application Publication
(10) Pub. No.: US 2009/0056599 A1
(43) Pub. Date: Mar. 5, 2009

(54) Safe locking mechanism

(76) Inventors: Robert Turner, St. Leonards (AU); Peter Taylor, St. Leonards (AU)

Correspondence Address: Allen C. Turner;TRASKBRITT, P.C., P.O.Box 2550, Salt Lake City, UT, 84110, US

(21) Appl. No.: 12/229,266

(22) Filed: Aug. 20, 2008

(30) Foreign Application Priority Data
Aug. 20, 2007 (AU) 2007904459

(51) Int. Cl. E05G 1/06

(52) U.S. Cl. 109/2

(57) ABSTRACT

A secure safe for dealing with large volumes of cash at point of sale and storing in a safe box, the safe including: a slidably mounted front access door; a note validator mounted in the door; a dual-level access means for securing the door at two different positions, wherein the dual-level access means includes a first locking stage that enables a retail operator to move the door to a first position where access to a note-receiving means in communication with the note validator is exposed; a second locking stage enabling a cash removal operator to move the door to a second position to expose the contents of the safe box; and the note validator being in communication with the safe box for storing validated notes in the safe box.

### PRIORITY CLAIM

This application claims the benefit of the filing date of Australian Provisional Patent Application Serial No. 2007904459, filed Aug. 20, 2007, incorporated herein by reference.

### FIELD OF INVENTION

This invention relates to a safe locking mechanism. More particularly, this invention relates to a point of sale safe locking mechanism.

### BACKGROUND ART

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

For point of sale retail services dealing with large volumes of cash, the problem of safe storage of large excess volumes of cash not required for service operations has been observed. To deal with this problem, an operator, such as a cashier, may be required to periodically remove excess notes from a cash register and to deposit these excess notes in a safe for later collection by armed guard. Internal antifraud procedures may require the operator to document the volume of cash being deposited, such as by the completion of a deposit slip. This process is not only time consuming and error prone, but open to fraud on the part of the operator.

Recently, electronic safes have been developed that include note validation devices. The note validation device will receive a note, scan and verify its authenticity and store it within a cassette. While this may improve the processing of large amounts of cash, such a safe device is vulnerable to attack by a robber. An exposed slot for receiving notes may be used as an access point for penetration using a screw driver, crowbar or other crude leverage instrument. Furthermore, where a safe door is located with hinges exposed, this presents further opportunity for attack to gain unauthorized access to the contents of the safe.

An object of the present invention is to ameliorate the aforementioned disadvantages of the prior art or to at least provide a useful alternative thereto.

### DISCLOSURE OF THE INVENTION

Accordingly, in one aspect of the invention, there is provided: a safe for receiving, validating and storing valuable items in the form of sheets, the safe including:
(a) a safe area for storage of the sheets and to which access is only obtainable in a first configuration of the safe;
(b) a first movable barrier securable to prevent access to the stored sheets in a second configuration of the safe;
(c) a validator:
   (i) only accessible for receiving sheets in the second configuration; and
   (ii) at least in the second configuration, in communication with the safe area to enable the delivery of sheets validated by the validator to the safe area; and
(d) a second movable barrier securable to prevent access to the validator and the safe area in a third configuration of the safe.

In another aspect of the invention, there is provided a secure safe for dealing with large volumes of cash at point of sale and storing in a safe box, the safe including:
a slidably mounted unit including a front door barrier and capable of assuming three different positions;
a note validator mounted in or on the unit;
a dual-level access means comprising at least two locking elements for securing the door in two of the three positions, wherein, the first position of a first locking stage of the dual-level access means corresponds to both elements being engaged whereby the safe box is inaccessible;
a retail operator can move the unit to a second position of a second-level locking stage where access to the note validator is provided;
a cash removal operator can move the unit to a third position to expose the contents of the safe box in a third unlocked stage enabling removal of the stored cash.

### OPTIONS AND PREFERMENTS

### Safe

The safe may include any of a variety of shapes and configurations. The safe may be substantially cylindrical. Preferably, the safe is box shaped. The safe may be a stand-alone unit. The safe may be portable in the sense that it can be moved, without too much trouble, from one location to another. Preferably, the safe is installed as a permanent fixture. The safe may be built in to the furnishings or wall of a building. The safe may be used in a public access context including use as an automatic teller machine (ATM) or as a safe deposit box. Preferably, legal and physical access to the safe is restricted to authorized personnel of an organization and support organizations such as armed guards.

Preferably, the safe is used at a point of sale venue. The safe may be installed in a wall, bench or other building, furnishing or furniture structure for use by one or more authorized operators at a retail venue. Preferably, the safe is installed in a retail service bench. Preferably, access to the safe is not available to the members of the public.

The safe may be made from a variety of materials, provided that they are suitable for the purpose. The safe may have a casing made predominantly from metal. The safe may include ceramic or other fire-resistant materials, for example, in the lining of the casing. The lining of the casing may include heat insulation. The safe may be made from a composite of steel, concrete, polymer fibers (such as polymer or carbon fibers) and alloys as the person skilled in the art of safe design will appreciate. Preferably, the casing is made from plate and/or hardened steel.

### Valuable Items

The valuable items may be any of a range of different types of sheets. The sheets include some type of decipherable, recognizable, calculable or identifiable indicia or information that may be processed by the validator. The sheets may be, for example, bonds, bank notes, checks or cash notes. The sheets may come in a range of sizes and may be made from a variety of materials. Preferably, the sheets are cash notes. Preferably, the cash belongs to a single currency.

### Safe Area for Storage

The safe area may include a tunnel, conveyor or delivery chute to a secure area. The secure area may be remote or local. The safe area preferably is a compartment. The compartment may be any one of a number of shapes, such as cylindrical, irregular or box-shaped. Preferably, the compartment is box-shaped and defines the safe box. The safe area may include means for stacking or otherwise storing the validated sheets in an orderly manner. The safe area may include a cassette including one or more compartments to store the one or more types of sheets.

### Validator

The validator is preferably mounted behind the second movable barrier. The validator may be mounted to the internal face of the second movable barrier and/or to the first movable barrier. The validator may include one or more modules, each validator module capable of processing a particular size or type of sheet. For example, the validator may include two validator modules, one module for processing $50 notes and a second module for processing $100 notes. The validator may include receiving means. The receiving means may include one or more slots to receive the sheets. The receiving means may include a bezel to facilitate guidance and correct entry of the sheet into the slot. Advantageously, the receiving means is located behind the second movable barrier and access to the receiving means is prevented in the third configuration.

The validator may be part of a validator-storage cassette module, so that there is a dedicated cassette for each validator module. This can facilitate the storage of like-type sheets in the same cassette, like-type sheets having been fed through a particular validator receiving slot. Accordingly, the safe may include two or more validator-storage cassette modules in an array behind the second movable barrier. The modular cassettes may be detachable from the validator component and the safe, so that a full or partially full cassette may be removed and substituted with an empty cassette.

### Movable Barriers

The first movable barrier and the second movable barrier may be movable relative to one another. The first and second barriers may be curved in shape. The first and second movable barriers may each have multiple panels that are angled with respect to each other. Preferably, however, the first and second movable barriers are each substantially planar or at least comprise one or more substantially outwardly planar surfaces.

The first and second movable barriers may be separated by a fixed space. The first and second barriers may be connected to one another, whereby the movement of one barrier causes movement of the other. Preferably, the first and second movable barriers are fixedly connected together, so that movement of one causes movement of the other in the same direction and to the same extent.

The second movable barrier is preferably substantially planar and presents an outward, secure surface of the safe in the third configuration. The second movable barrier is preferably in the form of a door adapted to securely cover the opening of the safe box.

The first movable barrier may be a substantially planar member oriented parallel to the second movable barrier. However, the first movable barrier may comprise at least one panel attached at right angles to the second movable barrier. The first movable barrier may include multiple panels whereby to define a box-shaped compartment in which the validator is partially mounted. For example, the first movable barrier may comprise a roof panel, two spaced and parallel side walls and a floor member. The validator receiving means may be located in one of the panel members of the first movable barrier. For convenience, the receiving means is mounted so that its opening for receiving sheets is mounted for access through a roof panel of the first movable barrier. Preferably, the first movable barrier comprises a single roof panel and optionally a gap-covering flange at right angles thereto.

Preferably, the first and second movable barriers form part of a movable unit. The validator may be mounted on or in the movable unit. The movable unit may define a compartment or area that is accessible for providing access to the stored sheets in the first configuration. The unit may be mounted for movement on a rail or track fixed to the internal surface of the safe. The unit may be mounted for sliding movement on the rail or track.

Restricted access to the safe area is preferably controlled by securing means. The securing means may include a multi-level locking means. The multi-level locking means may include a variety means whereby access to the safe area requires two separate actions and access to the validator involves a single action to provide intermediate access.

The locking means preferably includes a locking mechanism capable of assuming three different locking positions corresponding to the first, second and third configurations, with a locking mechanism actuated when the safe is in the second and third configurations. The locking means may include detent means capable of assuming two locking positions and one unlocked position, corresponding to the third, second and first configurations. Optionally, the detent means in the first configuration involves no locking engagement.

Preferably, the locking means includes a lever. The lever may be rigid or resiliently deformable. The lever may be pivotal or deflectable. The detent means may engage at least two different surfaces for lockable engagement in the second and third configurations. Preferably the detent means engages a ramp forming part of the locking means. Preferably, the ramp is stepped with at least two steps corresponding to the second and third configurations.

### BRIEF DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. In the drawings:

FIG. 1 is a perspective view of a prior art cash validator in a closed configuration corresponding to the second configuration in the present invention;

FIG. 2 is a perspective view of the prior art validator arrangement shown in FIG. 1 in an accessible state corresponding to the first configuration of the present invention;

FIG. 3 is a front perspective view of the top portion of a safe according to a preferred embodiment of the invention in the third configuration;

FIG. 4 is a full perspective view of the safe shown in FIG. 3 in the third configuration;

FIG. 5 is a top perspective view of the preferred embodiment shown in FIG. 3 in the second configuration;

FIG. 6 is a top perspective view of the preferred embodiment of FIG. 3 shown in the first configuration;

FIG. 7 is a perspective view of the preferred embodiment shown in FIG. 3 in the second configuration;

FIG. 8A is a schematic front elevation view of the preferred embodiment shown in FIG. 3 with the second movable barrier (not shown) to reveal the locking mechanism;

FIG. 8B is a schematic side elevation view of the locking mechanism and slide shown in FIG. 8A in the third configuration;

FIG. 9A is a schematic front elevation view of the preferred embodiment shown in FIG. 8A, but in the second configuration;

FIG. 9B is a schematic side elevation view of the preferred embodiment shown in FIG. 9A;

FIG. 10A is a schematic front elevation view of the preferred embodiment shown in FIG. 8A, but in the first configuration;

FIG. 10B is a side elevation view of the preferred embodiment shown in FIG. 10A.

### DETAILED DESCRIPTION OF THE INVENTION

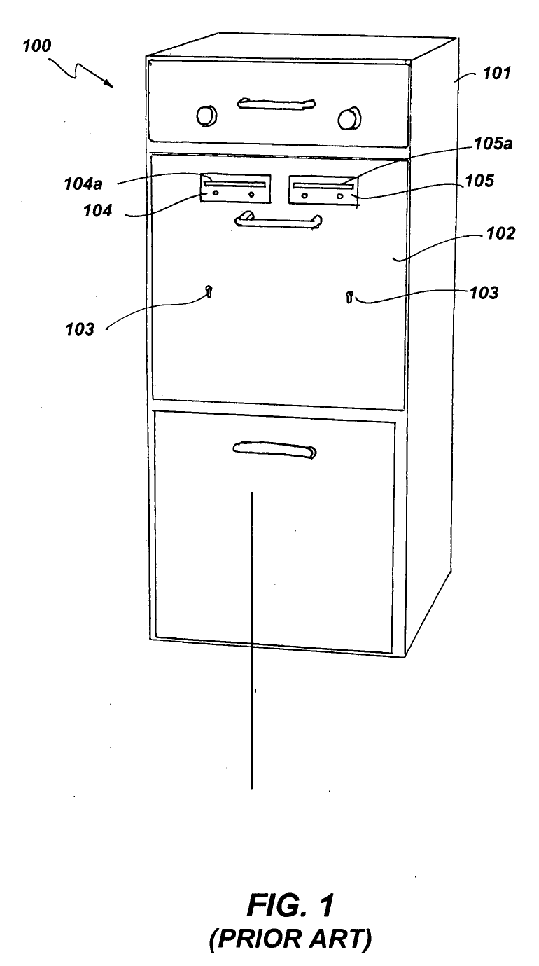

FIG. 1 shows an example of a prior art validator and secure box 100 comprising a cabinet 101 housing a slidable drawer 102 having a dual-locking mechanism operable by separate and non-identical keys adapted to actuate locks 103. In this second configuration, access to a pair of validators 104, 105 is possible through receiving slots 104a, 105a.

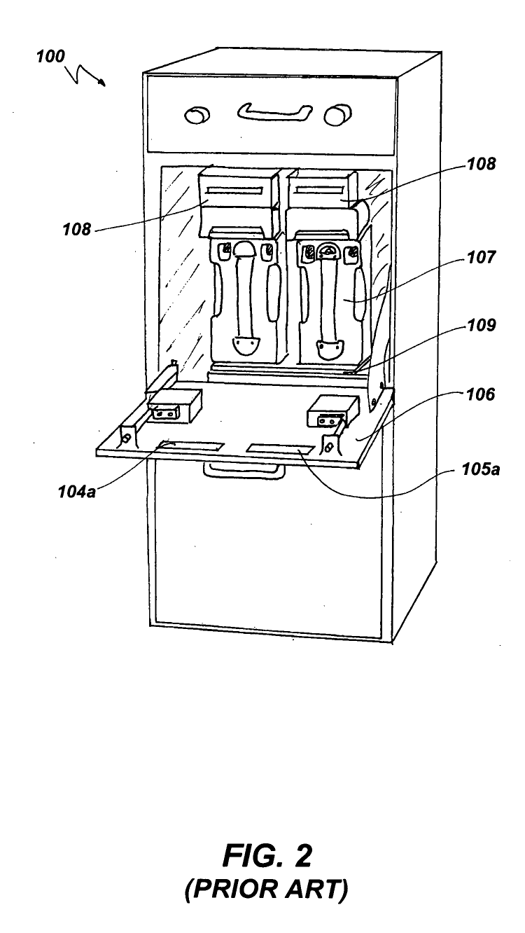

In use, access to the internal secure box contents requires the use of the two different keys that operate the locks 103. Typically, one key will be held on site by, for example, a cashier or manager and the second key will be held by a collection agency, such as an armed guard. Accordingly, access to the validators 104, 105 in the second configuration is available, even when the prior art secure box 100 is fully locked in the second configuration. The exposed validator slots 104a, 105a do not comply with international or Australian standards for safes. Such requirements involve tests of whether a safe could withstand attack by a robber for a specified period of time (e.g., 20, 30 or 50 minutes) whereby to form a 20 mm gap in the outer casing of the safe. In prior art secure boxes of the type shown in FIGS. 1 and 2, the slots 104a, 105a are typically of the dimensions 50 mm×120 mm and the validator receiving slots are primarily made of molded plastic parts. Furthermore, with reference to FIG. 2, the door 106 providing the removable and lockable barrier protecting the secured contents 107 is limited to 10 mm to 15 mm in thickness because the slots 104a, 105a must be sufficiently short in length to enable easy communication with the validator receiving means 108. This leaves the door 106 vulnerable to attack. Furthermore, the hinged door 106 that is typical of prior art safes and secure boxes such as that shown in FIGS. 1 and 2 is mounted upon hinges that present a further point of vulnerability to attack by a person attempting unauthorized access.

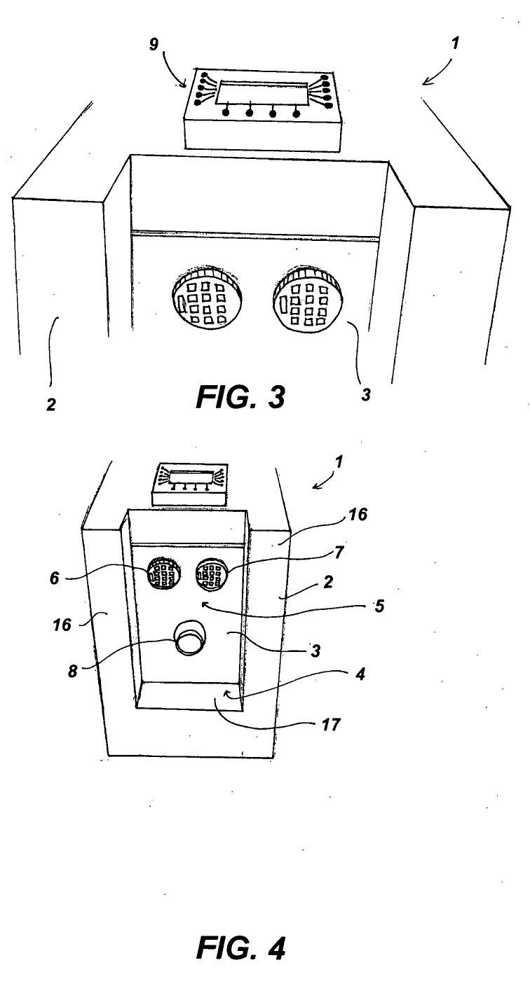

It is noted that the validator-cassette module 107, 108 is the same as that used in the preferred embodiment of the present invention to be described with reference to FIGS. 3 through 10B. The validator-cassette module 107, 108 is shown in FIG. 2 with the receiving means 108 facing outwardly (out of the page) for reception of cash notes fed in from a generally horizontal approach. In the preferred embodiment of the present invention, this module is re-oriented with the receiving means 108 facing upwardly and the base of the cassette 107 currently shown in FIG. 2 mounted on a horizontal platform 109, instead facing rearwardly towards the rear of the safe box to be described below.

Referring to FIGS. 3 and 4, there is shown a validator safe 1 according to a preferred embodiment of the invention. The safe 1 includes a box structure 2 with a solid wall structure made of a composite of steel, concrete, fibers and other alloys, with a hardened steel outer casing. The walls and other panel surfaces (roof, floor and door 3) are preferably 50 mm to 90 mm thick in accordance with international and Australian safe quality standards. The door 3 is, in the third configuration shown in FIGS. 3 and 4, lockably secured in a recess 4, so that there are no apertures or easy leverage points presented to a potential robber.

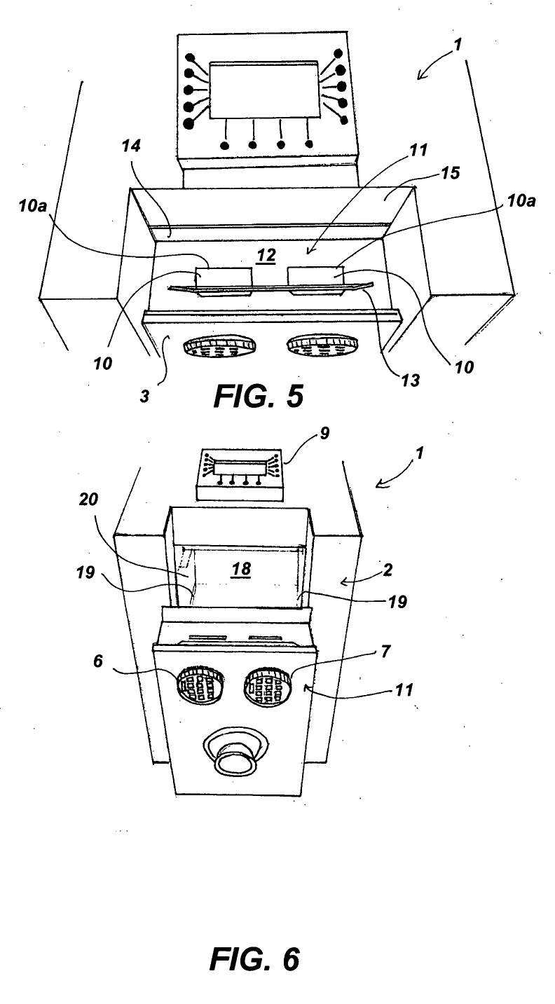

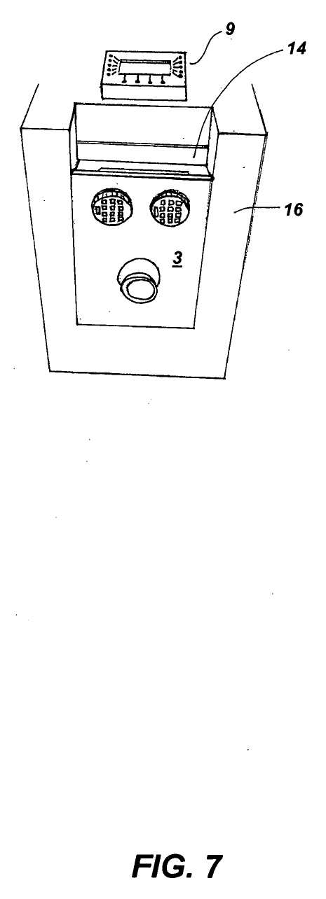

The locking mechanism 5 is actuated by a pair of independently operated keypads 6, 7 and a rotatable handle 8. The keypad 6 is exclusively operable by a first operator, such as a cashier, that enables the cashier to access the safe 1 independently to the security level of the second configuration shown in FIGS. 5 and 7. The actuation of the second keypad 7 enables a second operator, such as an armed guard, to access the safe 1, only in combination with the first operator of the keypad 6, to the security level of the first configuration shown in FIGS. 6, 10A and 10B. It will be appreciated that the locking means 5 could be actuated by any standard means such as key entry.

The safe 1 further includes a display 9 that displays data corresponding to the processing carried out by a validator as will be explained below.

With reference to FIGS. 5 and 7, the safe 1 is shown in which the door 3 has been unlocked to the level of the second configuration whereby to permit access to a pair of validator receiving means 10. Accordingly, the door 3 forms a second movable barrier.

The door 3 forms part of a slidable unit 11 that includes an upper panel 12. The upper panel includes slots 10a that are in registration with the respective receiving means 10 of validators mounted to the unit 11. To assist a first operator in feeding notes to be validated into the validator, a bezel 13 or other guide may be provided. The safe 1 includes two validators, although safes according to the invention may be provided with one, two, three, four or more validators. The safe 1 is equipped with two sets of software. The validator includes authentication software (for example, the commercially available Note Set software, which, is supplied by EMI Group) that checks for counterfeit, etc., and control software developed in-house by the applicants that controls the counting of the sheets in the form of cash notes, services the user interface display 9 and connects to a centralized point of sale computer, a basic operating system (BOS), ancillary communication devices associated with LANs, WANs for local and off-site recording and reporting. The validators may be adapted to receive specific cash denominations, such as $50 and $100 bills. In particular, it may be preferable that the safe 1 be configured to store high value notes that are unlikely to be required for exchange in cash transactions.

The bezel 13 is the same height or lower than the door 3 and rear flange 14, so that the bezel 13 fits under the rear panel 15 of the recess 4 in the third configuration shown in FIGS. 3 and 4.

The unit 11 in the second stage is shielded at its sides and floor by the side walls 16 and the floor 17 of the recess. Accordingly, the primary operator who has access to the safe 1 in the second configuration cannot get access to the contents of the safe 1 that are stored behind the panel 12 and flange 14, as well as the door 3.

Referring now to FIG. 6, there is shown the safe 1 in a first configuration in which full access is available to the safe contents contained in a safe box 18 defined by the safe structure 2. The safe box 18 provides a recess into which the unit 11, including the mounted validator-cassette modules mounted thereon, can slide into and out of according to the locked status level of the locking means 5. Access to the safe box 18 in the first configuration is only possible where the two-stage locking mechanism 5 is actuated first by the primary operator to achieve access corresponding to the second configuration, and by the second operator enabling the release of the locking mechanism 5 to allow the unit 11 to be pulled out to its full extent corresponding to the first configuration.

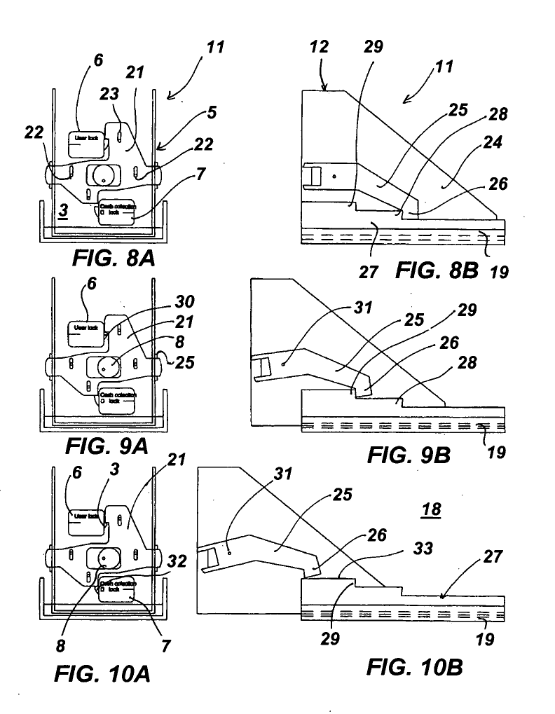

The unit 11 is mounted for sliding movement on a track or rail 19 extending along the internal side walls 20 of the safe box 18 as best shown in FIGS. 8B, 9B and 10B. As shown in FIGS. 8A, 9A and 10A (corresponding to the third, second and first configurations in that order), the locking mechanism 5 includes separately operable user lock 6 and cash collection locks 7 that are separately operable by the first operator and the second collection operator, respectively. The locking means 5 includes a vertical bracket 21 vertically reciprocatable within the unit 11 and guided by fixed pins 22 attached to the internal surface of the door 3 and coacting with a corresponding set of four slots 23 correspondingly positioned in the bracket 21. The unit 11 includes a chassis 24 that runs along the rail 19 by standard means such as that used for the running tracks of filing cabinet drawers strengthened to manage the load of the heavy door 3 and other weighty components of the unit 11.

The locking means 5 further includes a deflectable detent in the form of a pivotal lever 25 that includes a hook portion 26 that coacts with a ramp 27 mounted to the internal surface of the safe box 18. The ramp 27 includes three graduated levels and a pair of steps 28, 29.

As shown in FIG. 9, the user lock 6 operated by the first operator is activated by correct keypad entry of a personal identification number (PIN) so that a lock detent 30 is deflected downwardly enabling the bracket 21 by the operation of the handle 8 to be moved downwardly thereby forcing the lever 25 to rotate about its pivot 31 to lift the hook 26 over the first step 28 enabling the unit 11 to be partially slid out to a first extent corresponding to the second configuration in which the hook 26 now abuts the second step 29.

Referring to FIGS. 10A and 10B, actuation of both the user lock 6 and the cash collection lock 7 by the secondary operator enables the bracket 21 to be further lowered by the operation of the handle 8 whereby a cash collection lock detent 32 is released, so that the detents 30, 32 are both released. This causes the lever 25 to further pivot about pivot spigot 31 to rotate the hook 26 further upward enabling it to be lifted above the second step 29 and onto a third platform 33 of the ramp 27. The unit 11 is thus moved out to its full access position corresponding to the first configuration in which the collection operator can access the safe box 18 for removal of cash or other valuable sheets from the storage cassettes.

Accordingly, the two stage locking mechanism 5 enables a first operator, such as a cashier, to access a deposit slot 10a in registration with the receiving means of the validator 10 by unlocking to the access level corresponding to the second configuration. However, the first operator's key code is only able to unlock the slidable unit 11 to this first access level corresponding to the second configuration. To remove or empty the storage cassette, a second operator, such as a security guard, is required to enter a second key code into the keypad 7a to enable the slidable unit 11 to be further removed to its full extent corresponding to the access level of the first configuration. The cassettes may be removed for transport under armed guard and replaced with empty cassettes. Accordingly, both locks 6, 7 are required to be actuated before the safe box 18 can be fully accessed. The first operator's (cashier) key code allows opening for normal deposits. The second operator's (guard) key code alone will not access anything.

Throughout the specification and claims the word “comprise” and its derivatives is intended to have an inclusive rather than exclusive meaning unless the context requires otherwise.

It will be appreciated by those skilled in the art that many modifications and variations may be made to the methods of the invention described herein without departing from the spirit and scope of the invention.

What is claimed is:

1. A safe for receiving, validating and storing valuable items in the form of sheets, the safe including:
(a) a safe area for storage of the sheets and to which access is only obtainable in a first configuration of the safe;
(b) a first movable barrier securable to prevent access to the stored sheets in a second configuration of the safe;
(c) a validator:
(i) only accessible for receiving sheets in the second configuration; and
(ii) at least in the second configuration, in communication with the safe area to enable the delivery of sheets validated by the validator to the safe area; and
(d) a second movable barrier securable to prevent access to the validator and the safe area in a third configuration of the safe.

2. A safe according to claim 1, wherein the first and second movable barriers are oriented at right angles to one another.

3. A safe according to claim 2, wherein the first and second movable barriers are fixedly connected.

4. A safe according to claim 3, wherein the first and second movable barriers define a compartment.

5. A safe according to claim 1, wherein the first and second movable barriers form part of a movable unit.

6. A safe according to claim 5, wherein the validator is mounted to the unit.

7. A safe according to claim 1, further including a first securing means to secure the first movable barrier in the second configuration.

8. A safe according to claim 1, further including second securing means to secure the second movable barrier in the third configuration.

9. A safe according to claim 8, wherein the first and second securing means each form part of a locking means.

10. A safe according to claim 1, further including an opening to the safe area and to which the first movable barrier prevents access in the second configuration and the second movable barrier prevents access in the third configuration.

11. A safe according to claim 10, wherein the opening lies in an opening plane and the first and second movable barriers are mounted for movement in a direction perpendicular to the opening plane.

12. A safe according to claim 11, wherein the first and second movable barriers are mounted for movement on a rail or track.

13. A safe according to claim 12, wherein the first and second movable barriers are mounted for sliding movement on the rail or track.

14. A safe according to claim 13, wherein the locking means includes a lever capable of assuming three different locking positions corresponding to the first, second and third configurations.

15. A safe according to claim 14, wherein the locking means includes a pivotal lever.

16. A safe according to claim 15, wherein the locking means includes a stepped ramp to engage the pivotal lever.

17. A safe according to claim 16, wherein the locking means is controlled by at least two lock actuation means.

18. A safe according to claim 17, wherein the first lock actuation means is operable by a point of sale operator and the second lock actuation means is operable by a stored sheet collection operator.
